(19) United States
(12) Patent Application Publication
(10) Pub. No.: US 2008/0165090 A1
(43) Pub. Date: Jul. 10, 2008

(54) Plasma display panel

(76) Inventors: Jung-Suk Song, Suwon-si (KR); Young-Soo Seo, Suwon-si (KR); Sang-Hyun Kim, Suwon-si (KR)

Correspondence Address: ROBERT E. BUSHNELL, 1522 K STREET NW, SUITE 300, WASHINGTON, DC, 20005-1202, US

(21) Appl. No.: 11/984,099

(22) Filed: Nov. 13, 2007

(30) Foreign Application Priority Data
Nov. 20, 2006 (KR) 10-2006-0114608

(51) Int. Cl. G09G 3/28

(52) U.S. Cl. 345/60

(57) ABSTRACT

A plasma display panel includes: a first substrate of a first color; a second substrate of a second color and facing the first substrate; barrier ribs disposed between the first and second substrates to define discharge cells; address electrodes extending in a first direction on the first substrate and corresponding to the discharge cells; a lower dielectric layer covering the address electrodes; display electrodes extending in a second direction which crosses the first direction on the second substrate and corresponding to the discharge cells; an upper dielectric layer covering the display electrodes; and phosphor layers formed in the discharge cells. Since the barrier ribs, the dielectric layer and the protective layer are transparent, damage caused by coloring can be prevented. Since color scattering is avoided by reflection layers provided in discharge spaces, reflection brightness is reduced and brightness is improved. Since components constituting the plasma display panel have colors of a subtractive color mixture, bright room contrast is improved and display efficiency deterioration is prevented.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on the 20^{th} of Nov. 2006 and there duly assigned Serial No. 10-2006-0114608.

### BACKGROUND OF THE INVENTION

1. Technical Field

The present invention relates to a plasma display panel and, more particularly, to a plasma display panel for preventing damage which occurs when a barrier rib, a dielectric layer and a protective layer are colored, reducing reflection brightness, and improving brightness.

2. Related Art

In general, a plasma display panel uses a vacuum ultraviolet (VUV) ray emitted from plasma generated through a gas discharge so as to excite a phosphor material. The exited phosphor material generates red (R), green (G) and blue (B) visible light beams, thereby forming an image.

According to the shape of waveform of a driving voltage and the discharge cell structure, the plasma display panel is classified into a DC-type plasma display panel and an AC-type plasma display panel. The schematic structure of the AC-type plasma display panel (hereinafter, referred to as a ‘plasma display panel’) will now be described.

First, address electrodes are formed on a rear substrate. The address electrodes are covered with a dielectric layer. Barrier ribs are disposed between the address electrodes on the dielectric layer so as to have a stripe shape or a matrix shape. A front substrate faces the rear substrate with a distance therebetween. Display electrodes constructed with a pair of electrodes comprising a sustain electrode and a scan electrode are formed on the front substrate in a direction crossing the address electrodes. The display electrodes are covered with the dielectric layer and a protective layer (MgO protective layer). Discharge cells are formed in areas where the address electrodes on the rear substrate cross the display electrodes on the front substrate. Red (R), green (G) and blue (B) phosphor layers are formed in the discharge cells.

Millions or more of unit discharge cells are arranged in the plasma display panel having the aforementioned structure. When a discharge occurs in a discharge cell selected from the arranged discharge cells, a desired image is displayed.

Meanwhile, a visible light beam displayed by the plasma display panel may be mixed with an external light beam partially reflected from a front surface of the plasma display panel. In particular, if the external light beam is further irradiated inside the discharge cells under the condition that an external environment is bright (a bright room condition), a bright room contrast deteriorates, thereby degrading the capability of the plasma display panel in terms of actually displaying an image.

### SUMMARY OF THE INVENTION

According to an aspect of the present invention, a plasma display panel comprises: a first substrate colored with a first color; a second substrate facing the first substrate and colored with a second color; barrier ribs disposed between the first and second substrates to define discharge cells; address electrodes extending in a first direction on the first substrate and corresponding to the discharge cells; a lower dielectric layer covering the address electrodes; display electrodes extending in a second direction which crosses the first direction on the second substrate and corresponding to the discharge cells; an upper dielectric layer covering the display electrodes; and phosphor layers formed in the discharge cells.

In the aforementioned aspect of the present invention, the first color and the second color may be mixed each other by subtractive color mixture. Furthermore, the first (or second) color may be one of three primary colors of a subtractive color mixture, and the second (or first) color may be a mixed color of the remaining two colors among the three primary colors of the subtractive color mixture.

In addition, the first color may be complementary to the second color, the first color may be a chromatic color or a brown type color, the second color may be a chromatic color or a cyan type color, reflection layers may be formed in the discharge cells, and the reflection layers may be formed between lateral surfaces of the barrier ribs and the phosphor layers. Furthermore, the reflection layers may be formed between upper surfaces of the lower dielectric layer and the phosphor layers, or may be formed starting from the lateral surfaces of the barrier ribs to the upper surface of the lower dielectric layer. In addition, the reflection layer may contain aluminum.

Moreover, the barrier ribs may be transparent, the upper dielectric layer may be transparent, and the lower dielectric layer may be transparent. A part of the first substrate and a part of the second substrate may be colored with subtractive-mixed colors with the barrier ribs interposed therebetween. In addition, the upper dielectric layer may be covered with a protective layer, and the protective layer may be transparent.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partially exploded perspective view of a plasma display panel according to an embodiment of the present invention;

FIG. 2 is a cross-sectional view taken along line II-II of FIG. 1;

FIG. 3 is a plan view illustrating reflection layers formed in discharge cells of FIG. 1;

FIG. 4 is a partially exploded perspective view of reflection layers of FIG. 1; and

FIG. 5 is a view for explaining operational states of the reflection layers of FIG. 1.

### DETAILED DESCRIPTION OF THE INVENTION

Hereinafter, exemplary embodiments of the present invention will be described in detail with reference to the attached drawings. However, the present invention is not limited to the exemplary embodiments, but may be embodied in various forms. The present invention can be easily put into practice by those skilled in the art.

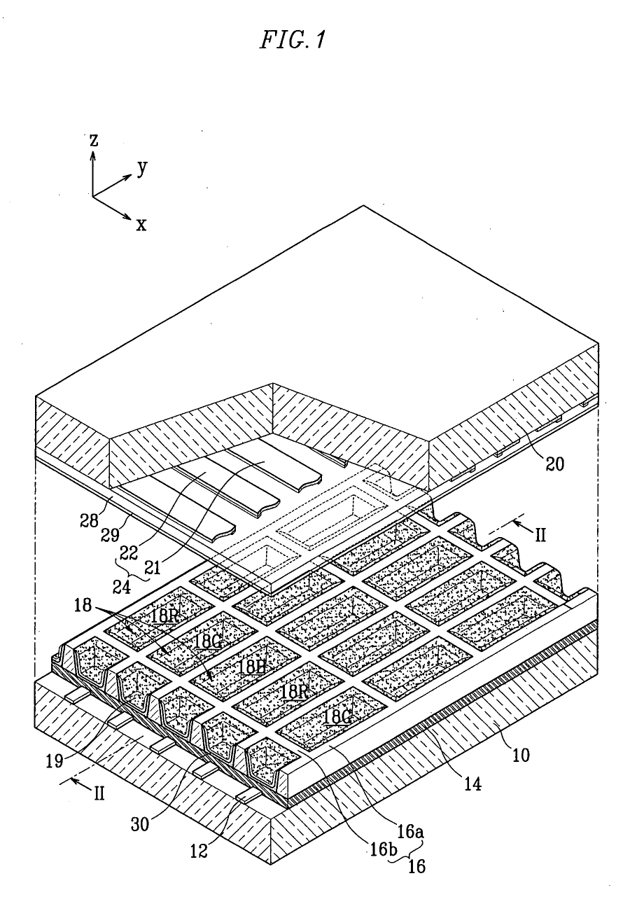

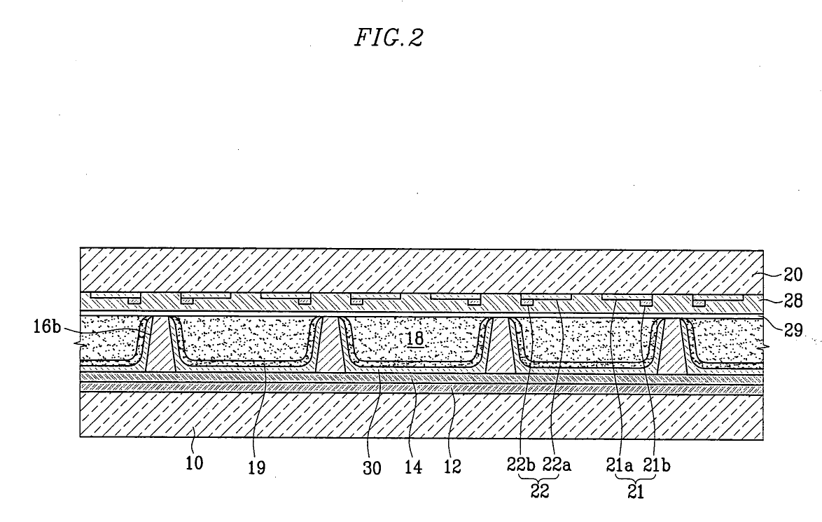

FIG. 1 is a partially exploded perspective view of a plasma display panel according to an embodiment of the present invention; and FIG. 2 is a cross-sectional view taken along line II-II of FIG. 1.

Referring to FIGS. 1 and 2, a plasma display panel according to an embodiment of the present invention includes a first substrate 10 (hereinafter, referred to as a ‘rear substrate’) and a second substrate 20 (hereinafter, referred to as a ‘front substrate’) which face each other with a predetermined distance therebetween.

The rear substrate 10 is colored with a first color. The front substrate 20 is colored with a second color.

The first (or second) color is colored with one color selected from three primary colors of a subtractive color mixture. The second (or first) color is a mixed color of the remaining two colors among the three primary colors of the subtractive color mixture.

The first and second colors may be complementary with respect to each other.

Specifically, if the first color which is colored with a chromatic color is selected to be a brown type color, the second color is colored with a cyan type color. In this case, the front substrate 20 and the rear substrate 10 may have colors of a subtractive color mixture, or may have complementary colors. However, the present invention is not limited thereto. Thus, other types of colors may be used as long as the first color and the second color are colors of the subtractive color mixture.

Since the front substrate 20 and the rear substrate 10 are colored with colors of the subtractive color mixture, an upper dielectric layer 28, a lower dielectric layer 14, barrier ribs 16, and a protective layer 29 may be transparent while not including coloring pigments.

Since the front substrate 20 and the rear substrate 10 are colored with complementary colors, even if the upper dielectric layer 28, the lower dielectric layer 14, the barrier ribs 16, and the protective layer 29 are transparent, bright room contrast may be significantly increased. In addition, reflection brightness of an external light beam is also reduced, and thus the image quality of the plasma display panel can be improved.

The coloring pigments are not additionally added when the upper dielectric layer 28, the lower dielectric layer 14, the barrier ribs 16, and the protective layer 29 are transparent, thereby avoiding damage caused by the coloring pigments.

That is, when the coloring pigments are added to the upper dielectric layer 28, the lower dielectric layer 14, the barrier ribs 16, or the protective layer 29, due to instability of the coloring pigments, gas bubbles may be produced in the dielectric layers 28 and 14, or the barrier ribs 16 may be damaged. Furthermore, a phosphor material may be dispersed when the barrier ribs 16 are damaged. However, according to the present invention, such problems can be avoided since the coloring pigments are not added to the dielectric layers 28 and 14 or the barrier ribs 16.

In order to form an image by using a gas discharge, the plasma display panel according to the embodiment of the present invention includes address electrodes 12, and sustain electrodes 21 and scan electrodes 22 forming display electrodes 24, which are disposed between the rear substrate 10 and the front substrate 20, and which correspond to discharge cells 18.

The address electrodes 12 are formed on the upper surface of the rear substrate 10, extend in a first direction (the y-axis direction of the figure), and sequentially correspond to the discharge cells 18 adjacent in the first direction. The address electrodes 12 are spaced apart from one another by a predetermined distance in a second direction (the x-axis direction in the figure) and correspond to the respective discharge cells 18. The address electrodes 12 disposed on the rear substrate 10 do not interfere with a visible light beam irradiated in the forward direction. Thus, the address electrodes 12 may be constructed with opaque electrodes (that is, metal electrodes having an excellent electrical conductivity).

The lower dielectric layer 14 covers the address electrodes 12. The lower dielectric layer 14 prevents the address electrodes 12 from being directly impacted by positive ions or electrons during a discharge, thereby protecting the address electrodes 12 against damage. Furthermore, the lower dielectric layer 14 forms and accumulates wall charge.

The sustain electrodes 21 and the scan electrodes 22 are formed on the lower surface of the front substrate 20 and correspond to the respective discharge cells 18, thereby forming a surface discharge structure. The sustain electrodes 21 and the scan electrodes 22 extend in the second direction crossing the address electrodes 12.

The sustain electrodes 21 and the scan electrodes 22 include transparent electrodes 21a and 22a, respectively, generating a discharge, and bus electrodes 21b and 22b which supply a voltage signal to the transparent electrodes 21a and 22a, respectively. Each of the transparent electrodes 21a and 22a generates a surface discharge in the discharge cells 18. In order to ensure aperture ratios of the discharge cell 18, the transparent electrodes 21a and 22a are made of a transparent material, for example, indium tin oxide (ITO). The bus electrodes 21b and 22b are made of metal having an excellent electrical conductivity so that high electric resistances of the transparent electrodes 21a and 22a are compensated for.

The sustain electrodes 21 and the scan electrodes 22 cross the address electrodes 12, and face each other while corresponding to the discharge cells 18. The sustain electrodes 21 and the scan electrodes 22 are covered with the upper dielectric layer 28. The upper dielectric layer 28 protects the sustain electrodes 21 and the scan electrodes 22 against a gas discharge. Furthermore, the upper dielectric layer 28 forms and accumulates wall charge during a discharge. The protective layer 29 is made of magnesium oxide (MgO) to protect the upper dielectric layer 28, thereby increasing a secondary electron emission coefficient during discharge.

The barrier ribs 16 are formed on the lower dielectric layer 14 between the rear substrate 10 and the front substrate 20 so as to have a predetermined height. Thus, the barrier ribs 16 define the discharge cells 18.

The barrier ribs 16 may define the discharge cells 18 in a matrix structure in combination with a first barrier member 16a extending in a first direction and a second barrier rib 16b extending in a second direction perpendicular to the first direction. Alternatively, the barrier ribs 16 may define the discharge cells 18 in a stripe structure in the presence of the first barrier member 16a only.

As described above, since the barrier ribs 16 are transparent while not including the coloring pigments, the barrier ribs 16 can be protected against damage caused by the coloring pigments.

In order to generate a vacuum ultraviolet ray, a discharge gas (e.g., a gas mixture containing neon (Ne) and xenon (Xe)) is filled in the discharge cells 18. Phosphor layers 19 are applied inside the discharge cells 18 so that the vacuum ultraviolet ray is absorbed so as to emit a visible light beam.

The phosphor layers 19 formed in the respective discharge cells 18 are formed by a phosphor paste which is annealed after being applied to lateral surfaces of the barrier ribs 16 and a surface of the lower dielectric layer 14. The phosphor layers 19 are formed by using the same colored phosphor materials in the discharge cells 18 formed in the first direction. Furthermore, the phosphor layers 19 are repeatedly formed by using red (R), green (G) and blue (B) phosphor layers in the discharge cells 18 repeatedly arranged in the second direction.

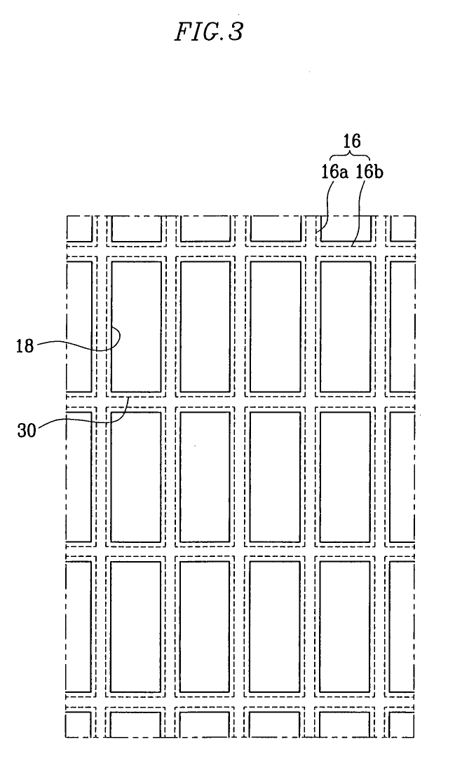

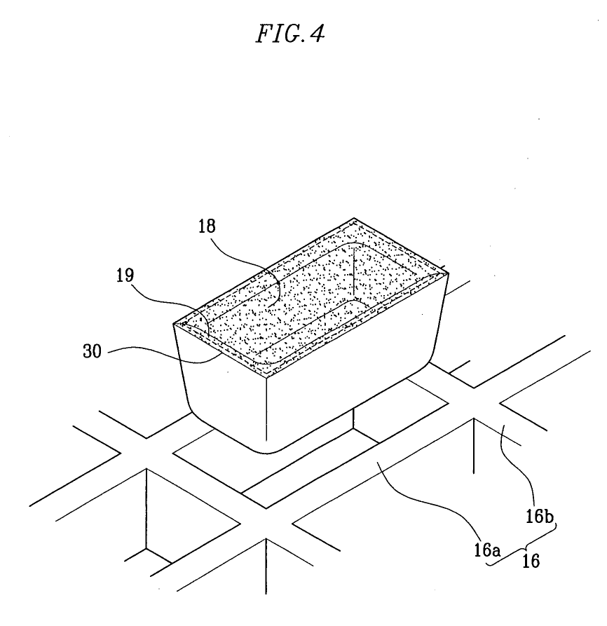

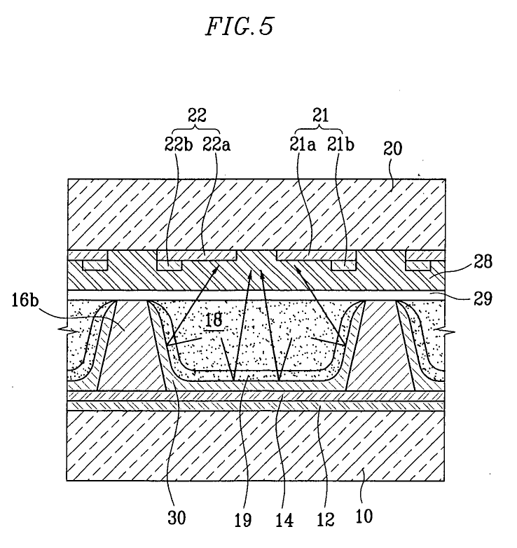

FIG. 3 is a plan view illustrating reflection layers formed in discharge cells of FIG. 1; FIG. 4 is a partially exploded perspective view of reflection layers of FIG. 1; and FIG. 5 is a view for explaining operational states of the reflection layers of FIG. 1.

Referring to FIGS. 3 thru 5, reflection layers 30 are formed between the phosphor layers 19, on one side, and the barrier ribs 16 and lower dielectric layer 14, on another side.

That is, the reflection layers 30 are formed starting from the lateral surfaces of the barrier ribs 16 to the upper surface of the lower dielectric layer 14. The reflection layers 30 are covered with the phosphor layers 19. If necessary, the reflection layers 30 may be formed only on the lateral surfaces of the barrier ribs 16 or the upper surface of the lower dielectric layer 14.

According to the embodiment of the present invention, the lower dielectric layer 14 or the barrier ribs 16 are transparent. In this case, color scattering may occur. The reflection layers 30 serve to avoid such color scattering. In particular, by reflecting a light beam from the lateral surfaces of the barrier ribs 16, brightness may be improved while reflection brightness is reduced. The reflection layers 30 may be made of aluminum (Al) so as to facilitate reflection of the light beam.

While the present invention has been particularly shown and described with reference to exemplary embodiments thereof, it will be understood by those skilled in the art that various changes in form and detail may be made therein without departing from the spirit and scope of the present invention as defined by the appended claims.

What is claimed is:

1. A plasma display panel, comprising:
a first substrate colored with a first color;
a second substrate facing the first substrate and colored with a second color;
barrier ribs disposed between the first and the second substrates so as to define discharge cells;
address electrodes extending in a first direction on the first substrate and corresponding to the discharge cells;
a lower dielectric layer covering the address electrodes;
display electrodes extending in a second direction which crosses the first direction on the second substrate and corresponding to the discharge cells;
an upper dielectric layer covering the display electrodes; and
phosphor layers formed in the discharge cells.

2. The plasma display panel of claim 1, wherein the first color and the second color are subtractive-mixed with each other.

3. The plasma display panel of claim 2, wherein one of the first and second colors is one of three primary colors of a subtractive color mixture, and another of the first and second colors is a mixed color of a remaining two colors among the three primary colors of the subtractive color

4. The plasma display panel of claim 1, wherein the first color is complementary to the second color.

5. The plasma display panel of claim 1, wherein the first color is chromatic color.

6. The plasma display panel of claim 5, wherein the first color is brown.

7. the plasma display of claim 1, wherein the second color is a chromatic color.

8. the plasma display panel of claim 7, wherein the second color is cyan.

9. the plasma display panel of claim 1, further comprising reflection layers fromed in the discharge cells.

10. The plasma display panel of claim 9, wherein the reflection layers are formed between lateral surfaces of the barrier ribs and the phosphor layers.

11. The plasma display panel of claim 9, wherein the reflection layers are formed between upper surfaces of the lower dielectric layer and the phosphor layers.

12. the plasma display panel of claim 9, wherein the reflection layers are formed on an area from lateral surfaces of the barrier ribs to an upper surface of the lower dielectric layer.

13. The plasma display panel of claim 9, wherein the reflection layer conatains aluminum.

14. the plasma display panel of claim 1, wherein the barrier ribs are transparent.

15. The plasma display panel of claim 14, wherein a part of the first substrate and part of the second substrate are colored with subtractive-mixed colors, the barrier ribs being interposed therebetween.

16. The plasma display panel of claim 1, wherein the upper dielectric layer is transparent.

17. The plasma display panel of claim 1, wherein the lower dielectric layer is trans parent.

18. The plasma display panel of claim 1, wherein the upper dielectric layer is covered with a protective layer and the protective layer is transparent.
